(19) United States
(12) Patent Application Publication
(10) Pub. No.: US 2016/0110959 A1
(43) Pub. Date: Apr. 21, 2016

(54) SUB-GAME CONSTRUCTED VARIABLE HAND POKER

(71) Applicants: Andrew Felsher, Bell Canyon, CA (US); Julie Uribe, Encino, CA (US)

(72) Inventors: Andrew Felsher, Bell Canyon, CA (US); Julie Uribe, Encino, CA (US)

(21) Appl. No.: 14/885,922

(22) Filed: Oct. 16, 2015

Related U.S. Application Data
(60) Provisional application No. 62/064,880, filed on Oct. 16, 2014.

(51) Int. Cl. G07F 17/32; A63F 1/00

(52) U.S. Cl. CPC G07F 17/3267; A63F 1/00; G07F 17/3293; G07F 17/3276; A63F 2001/005

(57) ABSTRACT

Disclosed herein are methods of playing a card game, which in some embodiments resembles poker. Players construct their hands by playing a sub-game, wherein their performance in the sub-game determines the number of cards in their hands. Players then attempt to construct the best poker hand possible based on a minimum hand-size, with some players with larger actual hand-sizes having more cards in which to do so. In some embodiments, the sub-game resembles a hi-low card game. Various betting schemes can be applied to the methods according to the present disclosure.

### CROSS REFERENCE TO RELATED APPLICATIONS

This application claims the benefit of U.S. Provisional Application Ser. No. 62/064,880 to Andrew Felsher, et al., entitled SUB-GAME CONSTRUCTED VARIABLE HAND POKER, filed on Oct. 16, 2014, which is hereby incorporated herein in its entirety by reference.

### BACKGROUND OF THE INVENTION

1. Field of the Invention

Described herein are novel methods of playing a card game utilizing physical cards, or utilizing an electronic-machine particularly configured to interact with a user, which can further incorporate aspects of betting and/or gambling, for example, to adapt the present methods to a casino setting.

2. Description of the Related Art

Card games are a long-lived pastime and an integral part of American cultural history. From the playing of card games, such as poker and faro in late 1800's western saloons to the blackjack variations in modern casinos in Las Vegas and Atlantic City, card games remain a favorite hobby and a staple of American culture.

Although the type and number of cards has varied throughout history, most modern card games are played with one or more decks comprising of fifty-two cards. The cards found in a standard fifty-two-card deck include nine numbered cards, typically numbered sequentially from 2-10, three “face” or “royal” cards, corresponding to jack, queen and king, and one ace. These amounts and values are typically duplicated over four “suits” corresponding to clubs, diamonds, hearts and spades, to produce the fifty-two cards in the standard deck. In addition to the standard fifty-two cards, additional cards can be added and given special meanings. For example, some standard decks contain one or more “joker” face cards, which can be said to be “wild” and correspond to any value or multiple values as needed for a particular game.

However, it is also important to note that variants of the standard fifty-two card-deck are often used in card games or two or more multiple decks can also be used. For example, a pinochle deck comprises 48 cards with four suits: and two of each card from 9 to ace. In Spain, card games are often played with 52, 48 or 40 cards and different suits (i.e. coins, cups swords and clubs) are used. A French deck can have 5 suits and 65 cards. Six suit and eight suit decks have also been utilized for various card games.

One popular card game is poker, of which there are many variations. Poker, although always a favorite of card players, has recently witnessed a spike in mainstream popularity with events, such as the World Series of Poker being broadcast on television and many poker tournaments being held at casinos around the country. Poker typically involves one or more players being dealt a hand of cards from the above-mentioned standard fifty-two-card deck (or a pool of cards from two or more standard fifty-two-card decks). This hand comprises a set number of cards and the players compare their hand of cards, or their hand in combination with a group of community cards, to that of each other and/or that of a dealer.

In poker, various combinations of cards are given special meanings and ranks, which can be based upon the probability of assembling the combination. For example, a three of a kind can beat a pair or a four of a kind can beat a full-house (a three of a kind plus a pair in a five card hand). Those with the highest-ranked hand win. Some variations include allowing players to exchange cards from their hand for a randomly dealt card, or allowing a number of cards from each player's hand to be formed from a shared pool of public cards (i.e. community cards) dealt buy a dealer face up on the table.

Casinos attempting to turn a profit in gaming are constantly looking for the “next big thing.” Furthermore, individuals can tire of the standard card games available and are looking for new and exciting forms of entertainment that provide additional options not available from games, such as standard poker.

### SUMMARY

Disclosed herein are methods of playing a card game, which in some embodiments resembles poker. Players construct their hands by playing a sub-game, wherein their performance in the sub-game determines the number of cards in their hands. Players then attempt to construct the best poker hand possible, based on a minimum hand-size, with some players with larger actual hand-sizes having more cards in which to do so. In some embodiments, the sub-game resembles a hi-low card game. Various betting schemes can be applied to the methods according to the present disclosure.

In one embodiment, a method of playing a card game at a table or on a machine comprises: determining a minimum and a maximum hand size and ranking values of possible hands from a pool of cards, with the pool of cards comprising cards with at least two different values; playing a sub-game in which at least one player is dealt a player hand, the number of cards in the player hand determined by the card play of the at least one player during the sub-game; dealing cards to a dealer to provide a dealer hand comprising a number of cards equal to the number of cards in the player hand; and comparing the player and dealer to determine which hand has a higher ranking value.

In another embodiment, a method of playing a card game at a table or on a machine comprises: determining a minimum and a maximum hand size and ranking values of possible hands from a pool of cards, the pool of cards comprising cards with at least two different values; playing a sub-game in which two or more players are each dealt cards, with a first player being dealt a first player hand and a second player being dealt a second player hand, the number of cards in the first player hand determined by the card play of the first player during the sub-game and the number of cards in the second player hand determined by the card play of the second player during the sub-game; determining which of the first player hand and the second player hand comprises the fewest number of cards; dealing cards to a dealer to provide a dealer hand comprising a number of cards equal to the fewest number of cards between the first player hand and the second player hand; comparing the dealer hand and the hand comprising the fewest number of cards to determine which has a higher ranking value; dealing additional cards to the dealer, such that the cards in the dealer hand is equal to the hand comprising the greater number of cards between the first player hand and the second player hand; and comparing the dealer hand and the hand comprising the greater number of cards between the first player hand and the second player hand to determine which hand has a higher ranking value.

In yet another embodiment, a method of playing a card game at a table or on a machine comprises: determining a minimum and a maximum hand size and ranking values of possible hands from a pool of cards, the pool of cards comprising cards with at least two different values; playing a sub-game in which two or more players are each dealt cards, with a first player being dealt a first player hand and a second player being dealt a second player hand, the number of cards in the first player hand determined by the card play of the first player during the sub-game and the number of cards in the second player hand determined by the card play of the second player during the sub-game; determining which of the first player hand and the second player hand comprises the fewest number of cards; dealing cards to a dealer to provide a first dealer hand comprising a number of cards equal to the fewest number of cards between the first player hand and the second player hand; comparing the first dealer hand and the hand comprising the fewest number of cards to determine which has a higher ranking value; dealing a new hand of cards to the dealer, such that the dealer is dealt a second dealer hand comprising a number of cards equal to the hand comprising the greater number of cards between the first player hand and the second player; and comparing the second dealer hand and the hand comprising the greater number of cards between the first player hand and the second player hand to determine which hand has a higher ranking value.

These and other further features and advantages of the invention are apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows a flow diagram representing a method of card play incorporating features of the present invention;

FIG. 2 shows a schematic representation of an example method of card play according to an embodiment incorporating features of the present invention;

FIG. 3 shows a flow diagram representing the method of card play of FIG. 1 with a betting method incorporating features of the present disclosure;

FIG. 4 shows an example betting placement layout scheme that can be utilized with betting methods incorporating features of the present invention; and

FIG. 5 shows a schematic representation of an machine-based method of card play utilizing a device according to an embodiment incorporating features of the present invention.

### DETAILED DESCRIPTION

Embodiments incorporating features of the present invention can resemble some variations of poker in which the strength of hands is defined by poker rules. The rules of poker concerning which hand combinations beat which other hand combinations are widely known in the art and are also specifically enumerated below. It is important to note, however, that various other rules can be used to determine which combinations of cards beat which other combinations of cards.

It is also important to note that embodiments of games incorporating features of the present invention can be played with a standard fifty-two-card deck, two or more standard fifty-two-card decks, a modified standard fifty-two-card deck (for example, decks containing one or more “wild” cards or having some cards removed), variant decks as mentioned herein, such as pinochle decks, Spanish decks, French decks, original decks with cards that are marked with values, such that the deck comprises cards with at least two different values and/or any decks known in the art. Accordingly, it is understood that there is no intention to limit the scope of the embodiments of games described herein to only a standard fifty-two-card deck.

In embodiments according to the present invention, one participant or a machine assumes the role of the dealer and the remaining participants assume the role of the players, with one preferred embodiment being played with one dealer and 1-7 players. In embodiments incorporating features of the present invention, a player's hand can be constructed by playing a sub-game and comprises a variable number of cards. That is, instead of a player beginning the game of poker with a randomly dealt hand, the player must play a sub-game, with his or her performance in the sub-game affecting the quality of his or her starting poker hand.

An example of such a sub-game includes playing a “higher or lower game.” For example, the dealer can individually deal a single card to a player. The player must then guess whether a subsequent dealt card will be “higher” or “lower” in rank than the previously dealt card. If the player guesses correctly, he or she can keep the recently dealt card and add it to his or her hand. The greater number of correct guesses a player makes, the greater number of cards that player has in his or her starting poker hand. In some embodiments, similarly to some variations of poker, aces will be assigned the highest value and 2's will be assigned the lowest value.

In embodiments incorporating features of the present invention, a minimum and maximum hand-size is set, such that regardless of how a player performs in the initial sub-game, he or she at least obtains a minimum hand-size in which to play the poker round. In some embodiments, the minimum hand-size is three and the maximum hand-size is five. After each player is dealt his or her hand in accordance to the sub-game, the dealer is dealt a hand corresponding to each numbered hand by the players. The dealer does not engage in the sub-game, but instead is subsequently dealt a dealer hand. The dealer's hand can be compiled in a variety of ways. In some embodiments, the dealer can receive a separate hand for each player having the same number of cards in that player's hand.

For example, if there are three players having hands of three cards, four cards and five cards respectively, the dealer can deal himself or herself a three-card hand, a four-card hand and a five-card hand and play out those hands against the correspondingly numbered hands of the players. In one more preferred embodiment, the dealer deals himself a hand equal to the minimum hand-size and resolves this hand against players also having the minimum hand-size (i.e. number of cards in hand) utilizing poker rules or another pre-determined ranking scheme. The dealer then deals himself or herself cards to expand the dealer's current hand to the next lowest hand-size and play continues until that expanded dealer hand is resolved against all players with that expanded hand-size. This process is repeated until the dealer resolves equivalent-sized hands against all the players.

The goal of the game is to construct the best (e.g. highest ranked) hand possible equal to the minimum hand-size set above. So if the minimum hand-size is three, players will attempt to construct the best three card poker hand possible, with some players having multiple cards to choose from in which to accomplish this.

Various betting schemes can also be implemented in accordance with embodiments incorporating features of the present invention. For example, an ante bet can be made. This bet could be required to play the game and can correspond to the dealer “qualifying” or making a certain hand. For example, in some embodiments, the dealer can be said to “qualify” if he or she has a queen high or greater against a 3-card hand, a king-high or greater against a 4-card hand and an ace high or greater against a 5-card hand. This bet can be placed before any cards are dealt. The cards are then dealt to the players.

Once the players have been dealt their hands in accordance with the rules of the game. Each player may choose to “fold” and thus forfeit their ante bet or “play” and place a bet equal to their ante bet. If at least one player elects to “play,” the dealer deals him or herself a number of cards in accordance with the game rules above. After the game is played, if a player beats the dealer as the rules above set forth, the player is paid out on the ante and/or play bets. If the dealer “qualifies” as above, the winning player wins both bets, if the dealer does not “qualify” the winning player only wins one bet, typically, the ante bet.

It is understood that although the embodiments described herein refer to a physical card game, for example, one played at a table specifically configured for playing the game (e.g. having locations dedicated to placement of cards, etc.), the methods according to the present disclosure can also be utilized with a machine, such as an electronic machine, particularly adapted to accept user input corresponding to the choices the user makes in the physical game. For example, the machine can comprise a “Hi” button and a “Low” button for the sub-game and can comprise buttons relating to the various bets disclosed herein.

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring of the description of the invention.

Throughout this description, the preferred embodiment and examples illustrated should be considered as exemplars, rather than as limitations on the present invention. As used herein, the term “invention,” “device,” “method,” “present invention,” “present device” or “present method” refers to any one of the embodiments of the invention described herein, and any equivalents. Furthermore, reference to various feature(s) of the “invention,” “device,” “method,” “present invention,” “present device” or “present method” throughout this document does not mean that all claimed embodiments or methods must include the referenced feature(s).

Relative terms such as “higher,” “lower,” “greater” or “lesser” and similar terms, may be used herein to describe a relationship of one feature or value to another. It is understood that these terms are intended to encompass different orientations in addition to the orientation described herein.

Although the terms first, second, etc., may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

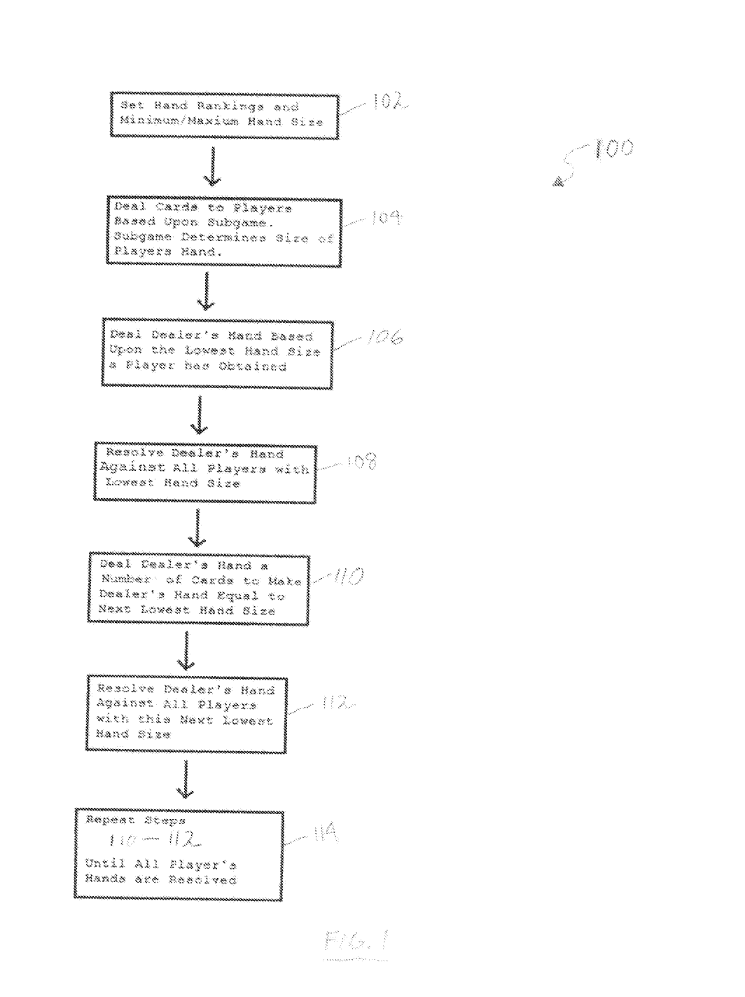

FIG. 1 shows a flow-diagram 100 representing a method of playing a card game incorporating features of the present invention. In an initial step 102, the hand rankings and the minimum and maximum hand-sizes for players' poker hands are determined. This initial step 102 need not be determined every time the game is played and can be set, allowing the game to proceed according to a standardized version of the initial step 102. For example, in a casino, it can be determined in a standardized version of the initial step 102 that certain card rankings apply and a certain maximum and minimum hand-size applies to all games played at that given casino.

In determining hand rankings in the initial step 102, various systems can apply. For example, standard poker hand rankings, which are known in the art, can be utilized. Typically, individual cards are ranked in the following descending order of numerical or face-card value: ace, king, queen, jack, ten, nine, eight, seven, six, five, four, three and two (deuce). Furthermore, hand combinations are ranked. This includes the following for a standard five-card hand poker game: ranked in order of value—highest to lowest: 1) A straight flush (sequentially numbered cards all in the same suit) beats all hands, with a royal flush (10-J-Q-K-A) being the highest possible hand, the ranking of a straight flush being based upon the highest card; 2) A four of a kind (four of the same numerically or face-valued card); 3) A full House (three of the same number-or-face-valued card and two of the same of another different number-or-face-valued card); 4) A flush (all cards having the same suit); 5) A straight (sequentially numbered cards); 6) Three of a kind (three of the same numerically or face-valued card); 7) Two pair (two of the same numerically or face-valued card and two of the same of a different numerically or face-valued card); 8) One Pair (two of the same numerically or face-valued card); and 10) High Card (the highest ranked numerical or face-valued single card a player has if none of the above hands were made).

As mentioned above, in one preferred embodiment, a three-card minimum hand-size is utilized. Accordingly, the above hand rankings can be modified according to three-card poker rules in which the following hand-ranks are utilized in descending rank: 1) Straight flush; 2) Three of a kind; 3) Flush; 4) Straight; 5) Pair; and 6) High Card.

It is important to note that while utilizing known poker hand rankings with methods of card gameplay according to the present disclosure, provides the advantage of individuals being immediately familiar at least with the ranking system of games incorporating features of the present invention, the present disclosure is not constrained to such rankings. The standard poker hand and card-value rankings can be modified, for example, an ace can be designated as a “one-value (i.e. less than a two)” or greater than a king (or can hold both values so that A-2-3-4-5 and 10-J-K-Q-A can both be considered valid straights) or the high-card hand can be eliminated as a winnable hand. Furthermore, various hand combinations not existing within standard recognized poker rules can be decided to beat other hand combinations, either arbitrarily or to adjust the odds of a player winning or losing.

In addition to determining hand and card rankings in the initial step 102, one also determines minimum and maximum hand-size. Various hand-sizes can be utilized which mirror versions of poker, such as three-card poker, five-card poker and seven-card poker. In one preferred embodiment, the minimum hand-size is set to three and the maximum hand-size is set to five. The minimum and maximum hand-sizes are utilized to play card games according to embodiments incorporating features of the present invention and the affect the hand-sizes have on the games will become apparent to one of ordinary skill in the art as methods according to the present disclosure are further discussed below.

After the initial step 102, one proceeds to the sub-game step 104. In the sub-game step 104, players play a sub-game to determine the number of cards that will make up the player's hand-size during the “poker steps” or “resolution steps” of the game, which are discussed below. As already mentioned, one such sub-game, which is a preferred embodiment is to play a hi-low game in which a player is dealt a card and then must predict whether the next card to be dealt to the player will be “higher” or “lower” in value than the previously dealt card. For example, using the above-mentioned scheme of descending order numerical/face-card value (i.e. ace, king, queen, jack, ten, nine, eight, seven, six, five, four three and deuce), a player dealt a king, might guess lower due to probability of most other cards being lower.

If the player guesses correctly in the hi-low sub-game during the sub-game step 104, the player adds the recently dealt card to his or her previously dealt card to begin forming a hand up to the number of cards equal to the maximum hand-size determined in the initial step 102. If the player guesses incorrectly, the player does not receive the dealt card as part of his or her hand, with the exception that a player always at least receives the minimum hand-size. For example, in games where three is the minimum hand-size, if a player is dealt a king and guesses lower and is then dealt an ace, the player has guessed incorrectly. As three is the minimum hand-size, the player gets to keep the king and the ace and another card is dealt to the player without the player further playing the hi-low game. This allows the player to still participate in the “poker steps” of the game. However, if the player had instead guessed correctly and then guessed correctly again and had a hand of king, ace, ten, and then guesses lower and is dealt a queen, the player would not get to keep the queen to make a four-card hand, as the player had already reached minimum hand-size and guessed incorrectly.

In the event of a tie—that is—where the player guesses higher or lower and the dealt card is of equal value, the game can be set in alternate configurations, such as a tie going to the dealer or tie going to a player. In other embodiments, another card is dealt to replace the card that created the tie, with the player guessing higher or lower for the replacement card and treating the original tie card as if it never was dealt. In other embodiments, in the event of a tie, another card is dealt and a correct guess breaks the tie allowing the player to keep the originally dealt card that created the tie. In still other embodiments, another card is dealt and, on a correct guess, the player can choose which of the two cards, the originally dealt tie-creating card or the newly dealt card, that the player wishes to keep to construct his or her hand. In a preferred embodiment providing a more significant boost in the “house” edge for the casino setting of the game, the tie simply goes to the dealer and is treated as though the player guessed incorrectly.

With the hi-low sub-game is a preferred and exemplary embodiment, it is understood that many other sub-games can be utilized in the sub-game step 104 to create a poker hand for the players. For example, players can play a hand of blackjack and keep the dealt cards if they do not “bust.” The standard rules of blackjack or “twenty-one” are readily known in the art. Accordingly, many different card-based and/or casino-based games can be utilized instead of the hi-low game to be utilized in accordance with embodiments according to the present disclosure. In a further embodiment, the sub-game provides additional betting opportunities.

While the embodiments described above discuss a sub-game in which the outcome of the sub-game is directly affected by the choices of a player, for example, a player guessing whether an upcoming card is higher or lower than a previously dealt card, in some embodiments, the sub-game limits or does not allow player choices and functions more randomly. In these embodiments, a player merely participates in the sub-game and does not make interactive decisions affecting the outcome of the sub-game. For example, in some embodiments of a hi-low sub-game, a given number value is chosen, for example a value of “8.” Then a rule is implemented as to how subsequently dealt cards will interact with this value. For example, in some embodiments, if a card dealt to a player during the sub-game step 104 has a value of “8” or lower, then the forced decision is “Hi” and if the subsequently dealt card is 9 or higher, the player has “won” that step of the sub-game as if the player had made a correct guess. Conversely, if a card dealt to a player during the sub-game step 104 has a value of “9” or higher, then the forced decision is “Low” and if the subsequently dealt card is 9 or higher, the player has “lost” that step of the sub-game as if the player had made an incorrect guess. Accordingly, when the present disclosure discusses the card play of the sub-game, it can be talking about both embodiments wherein the sub-game involves player decision and interaction or player participation a sub-game in which is more random.

The sub-game step 104 continues for each player until all players have assembled their hands. One advantage of the sub-game step of the present disclosure is that it creates an exciting new mode of play than the standard poker game as the players' performance in the sub-game step 104 directly affects their odds during the latter “poker steps.” Furthermore, the game can, and often does, result in players having different hand-sizes, which further creates a different and exciting new mode of gameplay.

After the sub-game step 104 is completed, the first dealer's hand step 106 is performed. In this first dealer's hand step 106, the dealer deals him or herself a hand, corresponding to the hand-size of the player or players having the lowest hand-size. The dealer does not typically engage in the sub-game, but instead simply deals himself or herself a hand; although in some embodiments, the dealer can instead engage in the sub-game. To illustrate by example, if there are five players and two players have the minimum hand-size of three (in those embodiments where three is the minimum hand-size), one player has a hand-size of four and two players have a hand-size of five, the dealer would deal him or herself a hand of three cards.

One important distinction is that the dealer is dealing him or herself an actual hand and playing against the hands that are generated by the players. Thus, the players are not comparing their sub-game-generated hands to a set value, for example, a chart indicating that a straight flush pays out a given pay scheme and three of a kind pays out another pay scheme, but are actually playing poker against a dealer who is playing a hand and comparing the player's hand with a variable value (i.e. the dealer's hand).

In a first resolution step 108, the dealers hand, which was obtained in the first dealer's hand step 106, is resolved against all players having the same hand-size as the dealer. This first resolution step 108 utilizes the hand and card value rankings determined in the initial step 102. The strength of a hand, both the players' and the dealer's, is based upon the minimum hand-size determined in the initial step 102, with a player or the dealer trying to make the best hand within the parameters of the minimum hand-size.

Therefore, according to the above, if the minimum hand-size is three and a player generated a hand-size of five in the sub-game step 104, the player will have five cards with which to construct his or her best three-card hand. For example, a player with three cards might have a hand of: deuce, deuce, three, but with the draw of an additional card, a four, the player would have a hand of: deuce, deuce, three, four. The best three-card hand in the first case is a pair (two deuces) the best card hand in the second case is a straight (a deuce, three and four).

After the first resolution step 108 is complete, the players who have resolved their hands are now out of the game until another round of play begins. The exception to this is where there are additional side bets to be resolved after all players have had their hands resolved against the dealer's hand. The game now proceeds to the second dealer's hand step 110. In the second dealer's hand step 110, the dealer receives additional cards to equal the next lowest hand-size. For example, using the above example of five players where two players have the minimum hand-size of three (which would have been resolved in the first resolution step 108), one player has a hand-size of four and two players have a hand-size of five, the dealer is dealt a hand of four cards, as four is the next lowest-numbered hand-size after three, where five was higher numbered than four.

There are at least two ways the dealer can generate his or her new hand-size. In one embodiment, the dealer discards his or her previous hand (the one resolved against the lowest numbered hands in the first resolution step 108) and draws four completely new cards. In a preferred embodiment, the dealer simply keeps the previous hand from the first resolution step 108 and simply receives a number of cards to make up the difference between his previous hand and the next lowest hand-size. Using the above example, if the dealer was previously dealt a three-card hand in the first dealer's hand phase 104, and the next lowest hand was the player having four cards, the dealer would simply receive an additional card in the second dealer's hand step phase 110 in order to raise the dealer hand-size from three to four.

After the second dealer's hand step 110 the dealer resolves the new hand against all players with equivalent hand-size in the second resolution step 112. Besides the different players resolving the hands against the dealer and the dealer's new hand-size, the second resolution step 112 proceeds in the same manner as the first resolution step, wherein the player's hands are compared to that of the dealer. As shown in flow-diagram of gameplay 100, further steps 114 (encompassing third or more dealer's hand steps and resolution steps) will be carried out by the dealer receiving a new hand-size for each next lowest player's hand, by repeating the above steps 110, 112 until all players have their hands resolved against the dealer's hand.

It is important to note that while the embodiments above are described as being all players versus the dealer, other embodiments wherein the players can play against each other or wherein the dealer is a neutral party and one of the players is dealt the dealers hand are all within the scope of the present disclosure.

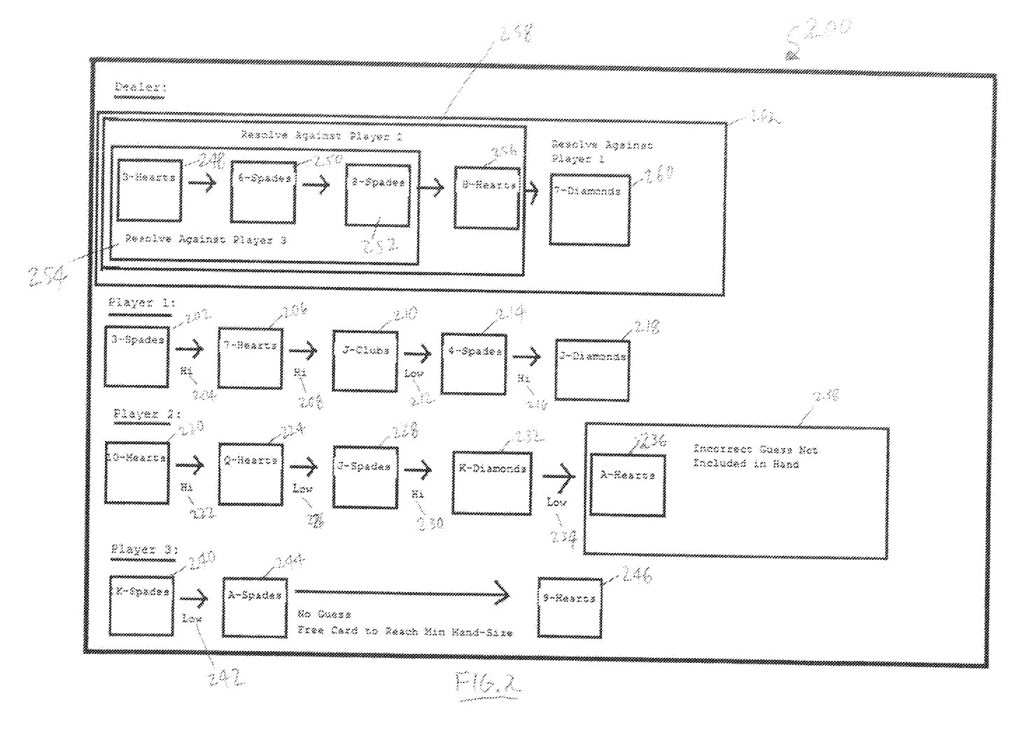

FIG. 2 demonstrates an example of gameplay of an embodiment incorporating features of the present invention. FIG. 2 describes in detail an example of gameplay 200. In the embodiment shown, the minimum hand-size is set at three and the maximum hand-size is set at five. The sub-game utilized is the hi-low sub-game. In the embodiment shown 200, there are three players and one dealer. The embodiment of FIG. 2 utilizes the individual card ranks mentioned above ranked in descending order of: ace, king, queen, jack, ten, nine, eight, seven, six, five, four three and deuce.

As shown in FIG. 2, the first player (i.e. Player 1) is dealt a three of spades 202; Player 1 engages in card play by guessing that the next card dealt will be “higher” than the three 204. The next card dealt to player 1 is a seven of hearts 206, a correct guess. Player 1 then guesses the next card will be higher than the seven 208 and is dealt a jack of clubs 210. Player 1 then guesses the next card dealt will be lower than the jack 212 and receives a four of spades 214. Finally, Player 1 guesses that the final card dealt will be higher than the four 216 and is dealt a jack of diamonds 218. Player 1 has guessed correctly at every instance and has achieved the maximum hand-size of five. Player 1 thus has five cards in which to construct the best three-card hand. The best three-card hand Player 1 can make utilizing standard poker rules is one pair of jacks (with a seven high to break a tie).

With continued reference to FIG. 2, the second player (i.e. Player 2) is dealt a ten of hearts 220, Player 2 and guesses that the next card dealt will be “higher” than the ten 222. The next card dealt to Player 2 is a queen of hearts 224. Player 2 then guesses the next card will be lower than the queen 226 and is dealt a jack of spades 228. Player 2 then guesses the next card dealt will be higher than the jack 230 and receives a king of diamonds 232. Finally, Player 2 guesses that the final card dealt will be lower than the king of diamonds 234 and is dealt an ace of hearts 236, an incorrect guess. The ace of hearts is thus not included in Player 2's hand 238. Player 2 thus has four cards in which to construct the best three-card hand. The best three-card hand Player 2 can make utilizing standard poker rules is a king-high straight (jack, queen, king).

With still continued reference to FIG. 2, the third player (i.e. Player 3) is dealt a king of spades 240, Player 3 then guesses that the next card dealt will be “lower” than the king 242. The next card dealt to Player 3 is an ace of spades 244, an incorrect guess. As Player 3 must make the minimum hand-size of three, Player 3 gets to keep the ace of spades and is further dealt a nine of hearts 246 to make the minimum hand-size of three cards without further playing the hi-low sub-game. In some embodiments, one or more players can bet on each hi-low guess.

As the hi-low sub-game is finished, the dealer is dealt a hand equal to the lowest hand-size a player has obtained. Player 1 has a hand-size of five, Player 2 has a hand-size of four and Player 3 has a hand-size of three. As Player 3's hand-size of three is the lowest, the dealer is dealt three cards consecutively without playing the sub-game. The dealer is dealt a three of hearts 248, a six of spades 250 and an eight of spades 252. The dealer then resolves this hand against all players with a three-card hand 254, in this case, only Player 3. The dealer only has an eight-high, whereas Player 3 has an ace-high. Player 3 beats the dealer and is paid out accordingly in gambling embodiments, such as those that are discussed further below.

As all three-card hands have been resolved, the dealer now looks for the next lowest hand-size among players; in this case, Player 2's hand size of four. To generate a four-card hand, the dealer simply is dealt a fourth card to the previously existing three-card hand and obtains an eight of hearts 256. The dealer then resolves this hand against all players with a four-card hand 258, in this case, only Player 2. The dealer now has a pair of eights; however, Player 2 has a king-high straight and beats the dealer. Player 2 is paid out accordingly in gambling embodiments, such as those that are discussed further below.

As all four-card hands have been resolved, the dealer now looks for the next lowest hand-size among players, which can only be five, as that is the maximum hand size set. Player 1 has a hand size of five, so the dealer is dealt a fifth card, a seven of diamonds 260 and resolves it against all players with a five-card hand 262, in this case, only Player 1. The dealers newest best three-card hand out of the five cards the dealer has to choose from is a straight (six, seven, eight), which beats the Player l's pair of jacks. Player 1 losses his or her bets (although not necessarily all his or her side bets as will be discussed in further detail below).

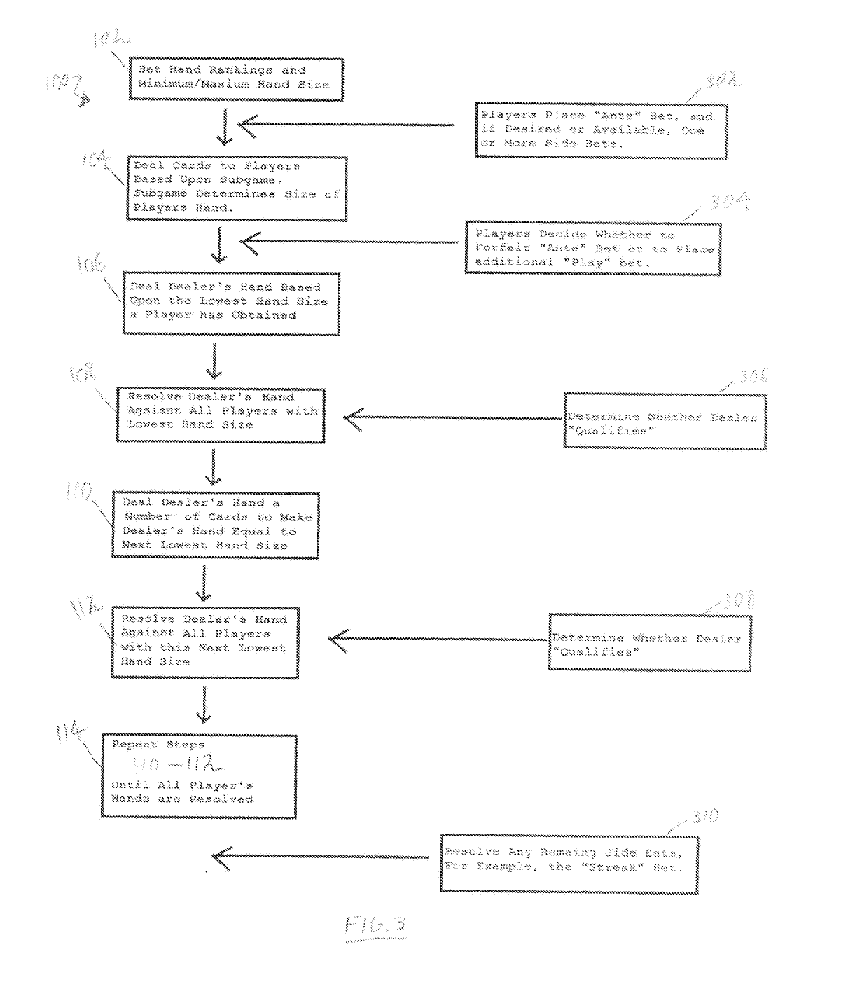

As the particulars of methods of playing card games incorporating features of the present invention have been thoroughly explained in detail, various gambling bets can now be discussed. FIG. 3 shows the method 100 of FIG. 1, complete with the initial step 102, the sub-game step 104, the first dealer's hand step 106, the first resolution step 108, the second dealer's hand step 110, the second resolution step 112 and the further steps 114. On the left side of the flow-diagram of the method 100 are example betting arrangements, which can be made at various stages of the method 100, including the stages shown. For example, after the parameters of the game are determined in the initial step 102, players can be required to place an “ante” bet 302 or “ante-in” as a requirement to play the game. This can be done prior to players seeing their hands or otherwise playing the sub-game in the sub-game step 104.

At the time of the ante bet 302 one or more side-bets can also be placed. Examples of such side-bet include “the five-card bonus bet” and the “streak bet.” A player making the five-card bonus bet is betting that he or she will make a five-card hand during the sub-game phase 102 of the method 100. The five-card bonus bet can have different odds than the other bets and can be tied to winning a hand or can be independent from wining the hand. The streak bet can correspond to a final round of play after the dealer and players have won or lost their hands. Essentially, a player making the streak bet is gambling on whether he or she can guess correctly to create a 10-card virtual hand (which is not actually played). The dealer deals cards in addition to the player's own hand and the players guess higher or lower. Thus, players with larger hand sizes have to guess less cards. Since the streak bet is more difficult, it usually gives the player more favorable payout odds. In some embodiments, players can also bet on the performance of the dealer or their fellow players.

Another side-bet that can be incorporated is the “at least” bet. This bet can be made prior to the cards being dealt and corresponds to the player betting that he or she will receive a hand that is of “at least” a certain value. One such bet is the a bet in which a player is betting that their hand will include a hand of at least one-pair (thus it can include a higher-ranked hand). Any number of common gambling bets that are known in the art can also be placed at this phase 302.

In still another side-bet embodiment, the players hand can be compared to a pay-table and the player can be paid out a side-bet win whether or not his or her card actually beat the dealer's hand. For example, a pay-table can be set up that if certain hands are made, for example, a four of a kind, the player wins a certain amount of money, even if the dealer has a straight flush and therefore beats the player's four of a kind. This can be a side-bet, for example, the player can determine whether he or she wants to place money for a potential pay-table payout or it can simply be a mandatory part of the game in some embodiments. As the players' hands can vary according to their performance in the sub-game, the pay-table can be constructed to encourage players to attempt to achieve a certain hand size. For example, three aces on the pay-table might pay out 2:1 odds, but four aces can pay out 5:1 odds; this encourages players to attempt to build larger hand sizes.

In yet another side bet embodiment, which we will refer to as the “seven card bonus bet” embodiment, a player makes the side bet at the beginning of the game and gets to resolve the side bet even if he or she loses or folds. This bet can be resolved in place of or in addition to the “streak bet” above and is resolved after the dealer's hand has been resolved against all players. Essentially, a player is gambling on whether he or she can make a hand that matches a “seven card bonus” pay-table, as with other pay-table bets disclosed herein. During resolution of this side bet, each player that placed the bet at the start of the game is given enough extra cards by the dealer to have a total of seven cards. Thus, if the player had only earned three cards from the initial sub-game they would receive four cards, if the player had earned a four-card hand they would receive three additional cards, and finally, if the player had earned five cards (and won an optional five-card bonus bet) they would receive two additional cards.

After the players have completed the sub-game 102 and thus have generated their hands, but prior to the dealer dealing him or herself a hand, the players can decide to forfeit their “ante” bets based on the strength of their hand or place a “play” bet 304 to continue playing against the dealer. In a preferred embodiment, the play bet must be equal to the ante bet. If at least one player elects to “play” 304 the game continues.

After or during any step wherein the dealer makes a hand 106, 110 or any step where the dealer resolves a hand against the players 108, 112 it can be determined whether a dealer “qualifies,” 306, 308 a status that can have an effect on the various bets made by the players. For example, the dealer can be said to “qualify” if he or she has a queen-high or higher against a 3-card hand, a king-high or higher against a 4-card hand and an ace high or higher against a 5-card hand. The strength of the qualifying hand can be set to a variety of different requirements, with the above-enumerated scheme being a preferable embodiment.

After the game is played—that is—after the further steps 114, winning players are paid out on the ante and/or play bets and remaining side bets, such as the streak bet are resolved 310. If the dealer “qualifies” as above, the winning player wins both his “ante” bet 302 and his “play” bet 304. If the dealer does not “qualify” the winning player only wins one bet, typically, the ante bet 302.

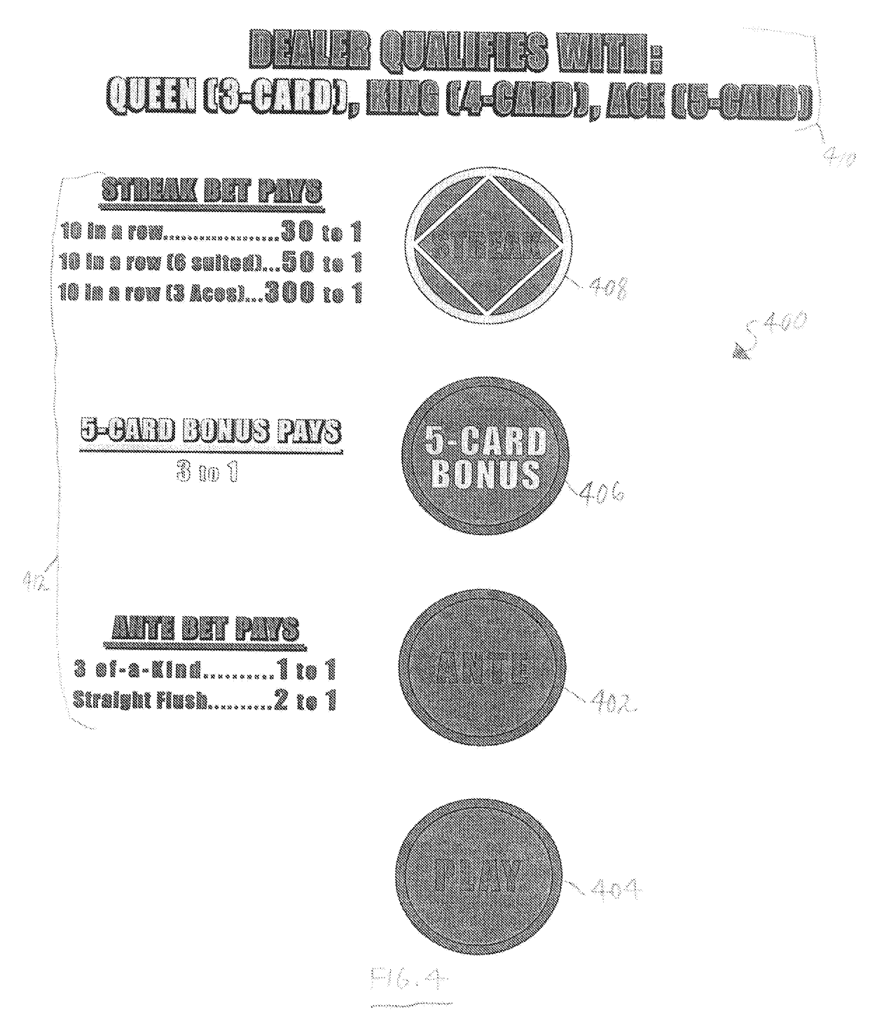

An example table-layout 400 where the various bets can be placed is shown in FIG. 4. The layout 400 includes places for players to set their chips to indicate their betting, including an ante-bet spot 402, a play-bet spot 404, a five-card bonus bet spot 406 and a streak bet spot 408. The layout further includes the qualification scheme for the embodiment 410 and the payout odds for the various bets 412.

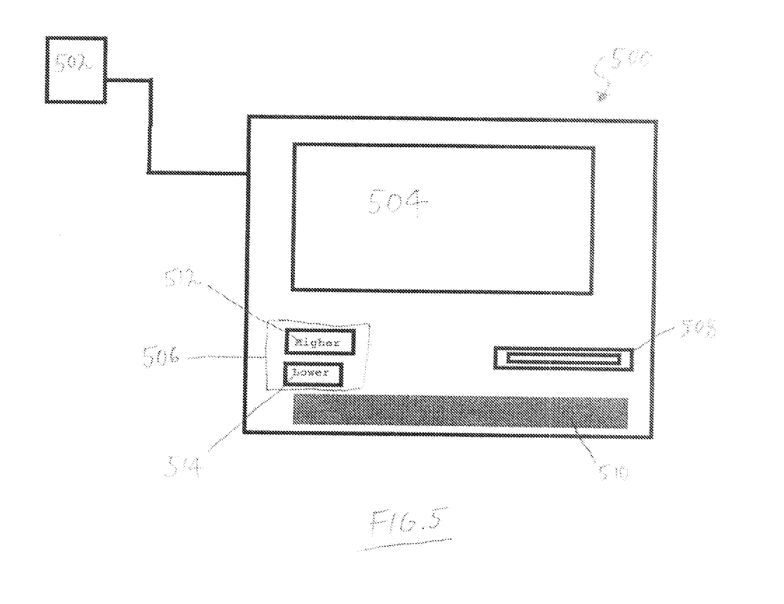

As described herein, embodiments incorporating features of the present invention include both machines and machine-based methods particularly configured to interact with a user and play games according to the present disclosure. FIG. 5 shows an example machine configuration 500 comprising at least one processor 502, which can be in the machine or located remotely and connect to the machine either through physical connection such as through a wire or wirelessly, at least one display 504, which a user can perceive in order to make decisions regarding the game, and at least one user interface 506, which the user can use to interact with the machine 500. The machine can further comprise memory for storing user choices and input and/or for tracking which virtual cards have been dealt, for example, random access memory (RAM), Read Only Memory (ROM), internal or external hard drives or various computer memory components known in the art of computer science and technology. In some embodiments, the card game can be configured as a non-transitory computer readable medium.

The machine can also comprise a feed 508 for accepting money or reading balances on credit cards or electronic gaming balance cards. It can be required that a user must pay to play the game and in some preferred embodiments, the user can use inserted funds to place bets, for example, the bets set forth according to the present disclosure or a different bet that is known in the art. In such “gambling” embodiments, a separate payment slot 510 can be included to dispense a user's winnings. Alternatively or in addition to the payment slot 510, the feed 508 can be configured to add funds to a player's credit or gaming balance card. Also, the machine 500 can be configured to deposit winnings into a separate account, such as a bank account or an online account set up for use with this game. Any other methods of paying a user his or her winnings known in the art can also be implemented with the present invention.

The user interface can comprise any structure known in the art to allow a user to interact with the machine 500, for example, to place bets and to make choices that affect the play and outcome of the game. In some embodiments, the user interface 506 can comprise one or more interactive structures, for example, buttons, touch pads, switches, etc., that allow a user to interact with the machine 500. In the example machine 500 shown in FIG. 5, two buttons are shown, a higher button 512 and a lower button 514. These buttons can be used to allow a user to provide input to the machine 500 during the higher-lower sub-game step of such embodiments according to the present disclosure. For example, the display 504 can show a digital representation of a card that the machine's processor 502 is configured to randomly generate to simulate shuffling and dealing. The user can use the lower button 514 to indicate that he or she predicts the next dealt digital card will be lower in value in accordance with the methods disclosed herein. In some embodiments, the display 504 can be combined with the user interface 506, for example, by having the display 504 comprise one or more portions that are interactive through use of touch-screen technology. Touch screen technology is known in the art and thus is not discussed in detail herein.

The methods of playing a card game according to the present disclosure can be easily adapted to be played on a machine, such as the machine 500 in FIG. 5. For example, the method 100 of FIG. 1 and the betting scheme set forth in FIG. 3 can be utilized with the machine 500 shown in FIG. 5. For example, the machine's processor 502 can be configured to play a game having a pre-selected minimum and maximum hand size, such as a minimum hand size of three and a maximum hand size of five; the player can risk money and place an ante bet utilizing funds deposited into the machine 500 in any suitable way, such as electronically and remotely, for example, through the internet, or via the machine's feed 508.

The machine 500 can then deal randomized digital cards to a player according to the previously set forth high-low sub-game, which are displayed on the display 504, while the player uses the interface 506 to make his or her choice regarding higher or lower. After the player has formed his or her hand according to the high-low sub-game, the player can use the interface 506 to determine whether to place a “play” bet according to the methods set forth herein or to fold and forfeit his or her ante bet. If the player decides to place the “play” bet, the machine's processor 502 can be configured to deal a randomized dealers hand of the some hand-size as the player constructed. The hands can then be resolved according to the methods described herein. The machine 500 can be further configured such that its interface 506 can allow a player to make any of the side bets set forth herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

We claim:

1. A method of playing a card game at a table or on a machine, comprising:
determining a minimum and a maximum hand size and ranking values of possible hands from a pool of cards, said pool of cards comprising cards with at least two different values;
playing a sub-game in which at least one player is dealt a player hand, the number of cards in said player hand determined by the card play of said at least one player during said sub-game;
dealing cards to a dealer to provide a dealer hand comprising a number of cards equal to the number of cards in said player hand; and
comparing said player hand and said dealer hand to determine which hand has a higher ranking value.

2. The method of claim 1, wherein said minimum hand size is three and said maximum hand size is five.

3. The method of claim 1, wherein said ranking values are determined according to the rules of poker.

4. The method of claim 1, wherein said at least one player places one or more bets.

5. The method of claim 4, wherein said one or more bets comprise a bet that said at least one player will achieve a certain number of cards based upon said sub-game.

6. The method of claim 4, wherein said one or more bets comprise an ante bet required to initiate said card game.

7. The method of claim 4, wherein said one or more bets comprise a play bet placed after said sub-game is completed, said play bet required to continue said card game.

8. The method of claim 1, further comprising determining whether said dealer hand comprises a minimum value.

9. The method of claim 8, wherein said method allows said at least one player to place one or more bets, payment of at least one of said one or more bets conditioned upon said dealer hand comprising said minimum value.

10. The method of claim 1, wherein said sub-game comprises dealing a first card to said at least one player and said at least one player guessing whether a subsequently dealt card will be higher or lower in ranking value than the previously dealt card.

11. The method of claim 10, further comprising an additional round of play after said step of comparing said player hand and said dealer hand to determine which hand has a higher-ranking value, said additional round of play comprising continuing said sub-game and adding additional cards to said player hand.

12. The method of claim 11, wherein said method allows said at least one player to place one or more bets as to the number of cards in said player hand after said additional round of play.

13. A method of playing a card game at a table or on a machine, comprising:
determining a minimum and a maximum hand size and ranking values of possible hands from a pool of cards, said pool of cards comprising cards with at least two different values;
playing a sub-game in which two or more players are each dealt cards, with a first player being dealt a first player hand and a second player being dealt a second player hand, the number of cards in said first player hand determined by the card play of said first player during said sub-game and the number of cards in said second player hand determined by the card play of said second player during said sub-game;
determining which of said first player hand and said second player hand comprises the fewest number of cards;
dealing cards to a dealer to provide a dealer hand comprising a number of cards equal to the fewest number of cards between said first player hand and said second player hand;
comparing said dealer hand and said hand comprising the fewest number of cards to determine which has a higher ranking value;
dealing additional cards to said dealer such that the cards in said dealer hand is equal to the hand comprising the greater number of cards between said first player hand and said second player hand; and
comparing said dealer hand and said hand comprising the greater number of cards between said first player hand and said second player hand to determine which hand has a higher ranking value.

14. The method of claim 1, wherein said minimum hand size is three and said maximum hand size is five.

15. The method of claim 1, wherein said ranking values are determined according to the rules of poker.

16. The method of claim 1, wherein said sub-game comprises dealing a first card to a player and said player guessing whether a subsequently dealt card will be higher or lower in ranking value than the previously dealt card.

17. A method of playing a card game at a table or on a machine, comprising:
determining a minimum and a maximum hand size and ranking values of possible hands from a pool of cards, said pool of cards comprising cards with at least two different values;
playing a sub-game in which two or more players are each dealt cards, with a first player being dealt a first player hand and a second player being dealt a second player hand, the number of cards in said first player hand determined by the card play of said first player during said sub-game and the number of cards in said second player hand determined by the card play of said second player during said sub-game;
determining which of said first player hand and said second player hand comprises the fewest number of cards;
dealing cards to a dealer to provide a first dealer hand comprising a number of cards equal to the fewest number of cards between said first player hand and said second player hand;
comparing said first dealer hand and said hand comprising the fewest number of cards to determine which has a higher ranking value;
dealing a new hand of cards to said dealer such that said dealer is dealt a second dealer hand comprising a number of cards equal to the hand comprising the greater number of cards between said first player hand and said second player; and
comparing said second dealer hand and said hand comprising the greater number of cards between said first player hand and said second player hand to determine which hand has a higher ranking value.

18. The method of claim 1, wherein said minimum hand size is three and said maximum hand size is five.

19. The method of claim 1, wherein said ranking values are determined according to the rules of poker.

20. The method of claim 1, wherein said sub-game comprises dealing a first card to a player and said player guessing whether a subsequently dealt card will be higher or lower in ranking value than the previously dealt card.
